(19) United States
(12) Patent Application Publication
(10) Pub. No.: US 2020/0101679 A1
(43) Pub. Date: Apr. 2, 2020

(54) Deflector Embedded In A Thermal System of Discrete Units

(71) Applicant: John Charles BORLAND, Winnipeg (CA)

(72) Inventor: John Charles BORLAND, Winnipeg (CA)

(21) Appl. No.: 16/621,545

(22) PCT Filed: Jun. 13, 2018
(86) PCT No.: PCT/CA2018/000118

§ 371 Date: Dec. 11, 2019

Related U.S. Application Data
(60) Provisional application No. 62/518,872, filed on Jun. 13, 2017.

(51) Int. Cl. B29C 70/54

(52) U.S. Cl. CPC B29C 70/54

(57) ABSTRACT

The present invention relates to a thermal system for use with a granular bed support. The granular bed support consists a volume adjustable retaining vessel filled with aggregate material. A thermal fluid is introduced into the volume adjustable retaining vessel inlet as is allowed to exit through an outlet. A deflector is incorporated into the volume adjustable retaining vessel to direct the thermal fluid towards a top surface of the granular bed support. The deflector shape can be modified to provide increased thermal flow to areas subject to differential cooling. The deflector can also be shaped to provide more consistent thermal transfers along the entire top surface of the granular bed support.

### FIELD OF THE INVENTION

The present invention relates to a thermal system for a granular bed support use in molding. More specifically, the present invention relates to a thermal system for a granular bed support for use in molding incorporating deflectors embedded in aggregate material contained within a volume adjustable retaining vessel.

### BACKGROUND OF THE INVENTION

The shaping and manufacture of plastic or composite parts typically requires the use of tooling or molds. In molding systems, there is a high cost and inefficiency of heating and cooling the mold. The thermal transfers into and out of the mold is an important factor affecting many aspects of part production, including but not limited to production cycle times, cost of manufacture, material viscosity, cavity fill, cosmetic surface quality, internal material stress and other properties of the parts affected by uniform thermal flows. Controlling and directing thermal flows can reduce pressure drops, control flow velocities, and control flow dynamics.

Existing systems attempt to address thermal transfers in several ways. Some existing molds use a series of conduits or holes throughout the tool through which a thermal liquid is passed to control the thermal properties of the part throughout the molding process. The thermal transfer in these designs occurs primarily along the conduit and may not be consistent across the surface of the part. Other thermal system use coolant flowing into a porous medium disposed within an injection molding component adjacent to mold wall to facilitate thermal transfer between the coolant and the and injected liquid plastic. However, these systems can be inefficient and expensive. There remains a need to provide improved control over the transfer of thermal energy to and from the mold in a cost effective manner.

### SUMMARY OF THE INVENTION

The invention pertains to a support bed for use in molding comprising an adjustable granular bed comprising aggregate material retained in a retaining vessel, at least a portion of the retaining vessel being of a flexible sheet material, an arrangement for fluidizing the aggregate material and at least one arrangement for stressing the aggregate material. The adjustable granular bed, in a stressed state of the aggregate material, has the flexible sheet material and stressed aggregate material shaped to generally uniformly support the rear support face of a molding component. The adjustable granular bed, when the arrangement for fluidizing the aggregate material is activated, being reconfigurable as the aggregate material is displaceable such that the shape of the adjustable support can be altered to follow the shape of the molding component and the arrangement for stressing the aggregate material causes jamming of the aggregate material and support of the molding component and the arrangement for fluidizing the aggregate material allows for reconfiguration of the aggregate material. The support bed further includes at least one thermal system to facilitate the circulation of a thermal fluid through the granular bed and a deflector for directing the thermal flow is contained within the granular bed.

In a further embodiment of the invention, the at least one thermal system has at least one inlet for introducing a thermal fluid into the support bed and at least one outlet through which the thermal fluid exits the support bed.

In yet a further embodiment of the invention the support bed further comprises at least one volume adjustment device for adjusting the internal volume of the support bed.

In yet a further embodiment of the invention the support bed the volume adjustment devices is attached to a wall of the retaining vessel.

In another embodiment of the invention the support bed the volume adjustment device is coupled to the deflector.

In yet a further embodiment of the invention, the at least one thermal system further includes a control system having a control apparatus for dynamically adjusting the temperature of the thermal fluid.

In yet a further embodiment of the invention, the support bed has a control apparatus dynamically adjusts at least one further property of the thermal fluid including pressure and flow velocity.

In yet a further embodiment of the invention, the at least one thermal system has multiple inlets.

In yet a further embodiment of the invention the at least one thermal system has multiple outlets.

In yet a further embodiment of the invention, the deflector is embedded within the aggregate material.

In yet a further embodiment of the invention, the deflector is coupled to at least one part of the granular bed.

In yet a further embodiment of the invention, the granular bed contains at least 2 regions, each region containing an aggregate having a different property from another region.

In yet a further embodiment of the invention, the differing property of the aggregate is at least one of the following; size, shape, density, material, hardness and conductance.

In yet a further embodiment of the invention, the deflector includes at least one insert coupled thereto to direct the flow of the thermal fluid.

In yet a further embodiment of the invention, the temperature of the deflector is controlled by a deflector thermal system.

In yet a further embodiment of the invention, the deflector includes sensors to communicate the temperature at a predefined point along the deflector to a control panel.

In yet a further embodiment of the invention, the deflector is of similar shape to the molding component supported on top of the support bed.

In yet a further embodiment of the invention, the deflector is comprised of multiple sections independent from one another.

In yet a further embodiment of the invention, the granular bed contains at least 2 regions, including at least an upper region and an adjacent region positioned below the upper region, and the top surface of the adjacent region is formed to the desired deflector shape and forms the thermal deflector.

In yet a further embodiment of the invention, the thermal system includes a network of conduits to distribute the thermal fluids to predetermined areas of the granular bed which require variation in temperature.

### BRIEF DESCRIPTION OF THE DRAWINGS

Preferred embodiments of the invention are shown in the drawings, wherein:

FIG. 1 is an illustration of the adjustable granular bed support;

FIG. 2 is a partial sectional view of a portion of the granular bed support showing the aggregate and interstices;

FIG. 3 is an illustration of the granular bed support and corresponding thermal system;

FIG. 4 is a partial sectional view of the granular bed support having a deflector with inserts embedded therein;

FIG. 5 is a cross section of a deflector having an additional thermal system embedded therein;

FIG. 6 is an illustration of an alternative embodiment of the invention wherein the deflector is formed of granular material;

FIG. 7 is an illustration of the thermal system integrated into an infusion molding apparatus;

FIG. 8 is an illustration of the thermal system integrated into a resin transfer molding with light mold apparatus;

FIG. 9 is an illustration of the thermal system integrated into a resin transfer molding apparatus;

FIG. 10 is an illustration of the thermal system as used in post process curing;

FIG. 11 is a partial cross section of a mold and aggregate showing channels in the backside of the mold;

FIG. 12 is an illustration of an alternative adjustable volume retaining vessel having rigid walls and a relief apparatus; and

FIG. 13 is an illustration of a granular bed support having a thermal system with a branched inlet.

### DETAILED DESCRIPTION OF THE PREFERRED EMBODIMENTS

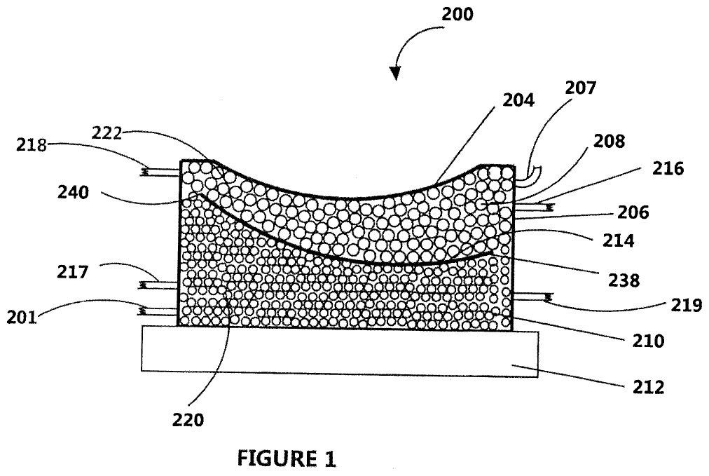

The invention pertains to a thermal system for use in a granular bed support used during the molding process. The granular bed support can be used in various types of molding and at various points in the molding operation. The granular bed support can be used alone or can be fitted with a mold, flexible membrane, a preformed flexible membrane, liner, or counter mold depending the application for which the granular bed will be used. FIG. 1 shows a generic granular bed support 200 having a volume adjustable retaining vessel 206 that houses aggregate material 208 and 210. The volume adjustable retaining vessel sits on base 212. It includes a fill port 207 for adding aggregate and further includes a vacuum port 219 and an air inlet port 217 to facilitate jamming and release respectively of the aggregate material 208 and 210. The aggregate material 208 and 210 is capable of being stressed to cause jamming of the aggregate as described in U.S. Pat. No. 9,211,660. Stressing of the aggregate typically includes compaction, vibration and then jamming by an actuator, although other methods are possible. This process essential locks the aggregate material to allow the engagement and support of the preformed mold, part, liner, or membrane. The granular bed support 200 additionally includes at least one inlet 216 and at least one outlet 218 to accommodate the introduction of a thermal fluid into the granular bed support 200. The volume adjustable retaining vessel further includes a drain 201 to drain the thermal fluid. Embedded within the aggregate 208 and 210 is a deflector 214 to direct thermal fluid.

It should be noted that all figures show aggregate units. These units are depicted randomly for simplicity but represent aggregate in the jammed state.

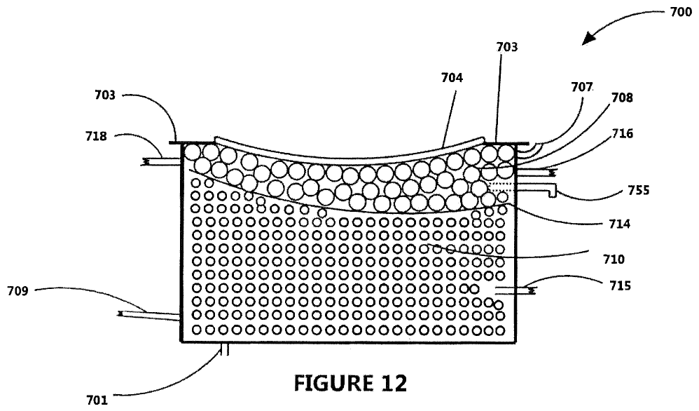

The volume adjustable retaining vessel could take different forms. For example, it could be made of a flexible material that conforms to the shape of the aggregate therein. Such an embodiment is shown in FIG. 1. Alternatively, the volume adjustable retaining vessel could be an open topped box 700 with rigid sides (for example a steel open topped box) as shown in FIG. 12. The top of the box 700 is fitted with a mold 704, liner, membrane or any other suitable material. In some embodiments, flanges 703 are used to fit the mold 704, liner, or membrane to the open top box 700. The box is partly filled with aggregate 710 to a nearly jammed state using the vacuum port 715 on a bottom layer. The deflector 714 is placed in the box and more aggregate 708 is added to a nearly jammed state. The aggregate is then fully jammed by applying a vacuum using vacuum port 715. As the thermal fluid enters the volume adjustable returning vessel through inlet 716, it passes through the volume adjustable retaining vessel and the aggregate and any air in the volume adjustable retaining vessel will start to expand. Thus, there is a relief apparatus 755, such as actuator, bladder, or relief valve, incorporated in the volume adjustable retaining vessel to accommodate for these changes. The relief apparatus 755 can be placed anywhere in the top layer of the Vessel. It is used to increase or decrease the volume and, therefore, pressure as required depending on whether the fluid is hot or cold.

The thermal fluid then exits through outlet 718. The embodiment further includes a fill port 707 for adding aggregate, an air inlet 709 for releasing the aggregate from its jammed state and drain 701 for facilitating the removal of the thermal fluid.

The granular bed may also include one or more volume adjustment devices. A volume adjustment device can be any apparatus that increases or decreases the internal volume of the support bed or granular bed. Examples include, but are not limited to, devices such as fluid bladders, actuators, cams, shape memory materials or other comparable devices. At least one of the volume adjustment devices can be attached to the deflector or support bed walls or they can be floating within the granular bed itself. They function to locally stress portions of the granular bed that may be difficult to stress by other means. The volume adjustment device may be activated in conjunction with other actuators to maintain the stability of the bed in localized locations. For example, the bladder may be expanded to locally stress the bed and a linear actuator can be activated to hold the locally stressed granular material in place after the bladder is de-activated. One advantage of this arrangement is that in the bed or layer of the bed that has thermal fluids passing through it, the vacuum causing isotropic stress must be turned off and yet be held stable as the fluids are introduced to the bed.

Returning to the general embodiment shown in FIG. 1, the aggregate 208 and 210 can include a wide range of materials, however preferred materials include granular material. Examples of such materials include but are not limited to silica sand, beach sand, marbles, ball bearings, shaped plastic particles, sand blasting particles such as metal beads of different sizes and shapes and materials, tumbling media such as washed river pebbles, glass beads, glass microspheres, crushed glass particles, propant particles (commonly used in the gas fracking area) of various sized, shapes, angularity, roundness hardness and surface roughness, walnut shell granules, aquarium sands, ceramic beads, plastic or ceramic coated sands, and sand blasting particles of all kinds and hardness. Additionally the aggregate could be hollow or be made from metal foam-core materials.

The granular material can exist in multiple states, for example a flowable, malleable and a solid state. In addition, these states can be permanent or semi-permanent on demand by stressing the discrete granular units that make up the media mass commonly called a granular bed. The units can be of any size, shape, or material and can be mixed so that regions within the volume adjustable retaining vessel 6 are partially or totally independent of other regions in the bed.

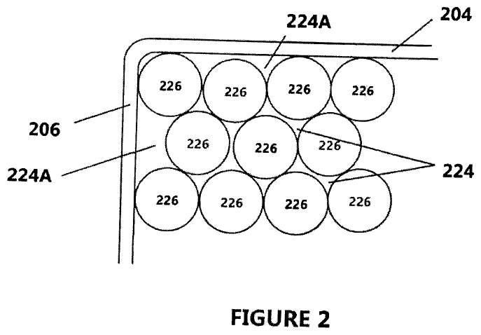

In the jammed state, the granular bed support consists of solid units of aggregate particulates 226 and interstices 224 or spaces between the units as shown in FIG. 2. These spaces make up approximately 30% of the volume within the envelope and can vary widely in volume depending on the characteristics of the aggregate particulates 226 and on the packing protocols used to create the bed and to stress the units within the bed. However the spherical units in the preferred embodiment have approximately a 30% porosity level.

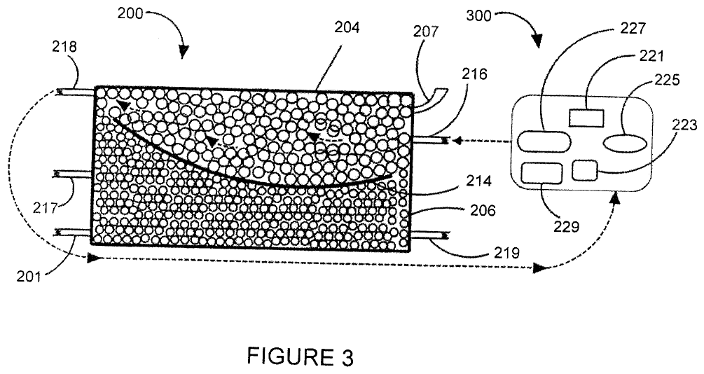

The granular bed support includes a thermal system 300 as shown in FIG. 3. This figure omits part of the aggregate to show an example flow of the thermal fluid through the volume adjustable retaining vessel. The flow of the thermal fluid is shown in broken line arrows. The thermal system includes an external control center 300 for controlling the flow of thermal fluid through one or more granular bed supports. The external control center 300 has a controller 225 including an apparatus to enable a user to adjust temperature, flow rate and other thermal fluid variables, a heat source 221 for heating the thermal fluid, a cooling source 223 for cooling the thermal fluid and a pump 227 for circulating the thermal fluid. Also included in the external control center 300 is a filtration system 229 for filtering the thermal fluid before being pumped into at least one volume adjustable retaining vessel. The pump 227 is coupled to the inlet 216. When in use, the pump 227 pumps fluid of the desired temperature through inlet 216, infiltrating the volume adjustable retaining vessel 206 in a random turbulent manner through the interstices 224 between adjacent aggregate particles 226. The thermal fluid also infiltrates the interstices 224a (shown in FIG. 2) between the volume adjustable retaining vessel 206 and the adjacent aggregate particulates 226. Gradually the apparatus reaches a thermal equilibrium state so that the area above the deflector reaches a uniform temperature. By embedding a deflector 214 in the granular bed support 200, the direction, flow velocity and turbulence of the thermal flow can be directed in a desirable pattern to manage the pressure drop in the volume adjustable retaining vessel 206 and maximize the transfer of energy to and/or from planned regions of the granular bed support to any part or mold which the granular bed may support. This provides improved control over the transfer of energy to and from the granular bed support saving time and energy in the part production process.

The deflector can be of any size, shape, rigidity, and construction, such as solid, perforated, lattice structures, layered, with support legs or support arms which could be connected to the envelope. It can also be constructed in a lattice structure with a solid layer on the face which is close to the mold skin. The deflector can be oriented in any direction and placed at any elevation within the envelope. In some embodiments, the deflector in partial contact with the mold skin or the bottom or sides of the envelope to facilitate positioning. The deflector 214 can be a single unit or made of a plurality of sections. In embodiments where the deflector is made of multiple sections, these sections may be either joined, separated, or tiered to improve thermal flow.

In a preferred embodiment, the deflector is positioned on an angle with respect to the top surface 204 of the granular bed support 200. The leading edge 238 of the deflector 214 is located lower in the volume adjustable retaining vessel 206 than the trailing edge 240 of the deflector 214. The thermal fluid enters the volume adjustable retaining vessel 206 via the inlet 216 at a first temperature T1 and as heat is lost to the aggregate and mold, part, or mold skin on top of the granular bed support, the thermal fluid exits the volume adjustable retaining vessel 206 through the outlet 218 a second, lower temperature T2. The angled deflector 214 increases the velocity of the thermal fluid as it moves from the inlet 216 to the outlet 218 because the thermal fluid is essentially funneled between the top surface 204 of the granular bed 200 and the deflector 214. Since the top surface 204 of the granular bed support 200 is exposed to an increasingly higher density of thermal fluid based on the distance from the thermal fluid inlet 216, the temperature difference of the top surface 204 of the granular bed 200 proximal the inlet 216 versus proximal the outlet 218 is reduced.

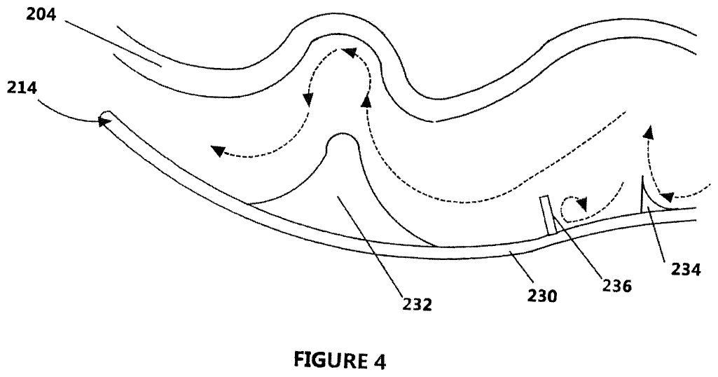

The deflector 214 can be of any shape, such as a flat plate as shown in FIG. 1. However, in a preferred embodiment shown in FIG. 4, contours can be added to the deflector in the form of inserts. The aggregate 208 has been omitted from this figure to provide clarity when illustrating example flows of the thermal fluid. These inserts 232, 234 and 236 are coupled to a deflector base 230 and are shaped to direct and deflect thermal flows. For example, insert 232 is shaped to direct the thermal fluid upward towards the top surface 204 of the volume adjustable retaining vessel 206 and then back down away from the top surface 204. Insert 234 is shaped to direct the thermal fluid upward and insert 236 is shaped to cause turbulence of the thermal fluid. These inserts can help direct heat to areas if a mold, part or mold skin subject to differential cooling and can provide more consistent thermal changes across the mold, part, or mold skin.

The deflector 214 can alternatively be essentially the same shape to the mold or part itself. In this embodiment, the deflector can be manufactured by taking an impression off the mold or part and creating the deflector matching the mold or part shape based on the impression. Alternatively, the deflector can be made using a 3D printer or any other suitable means of manufacture.

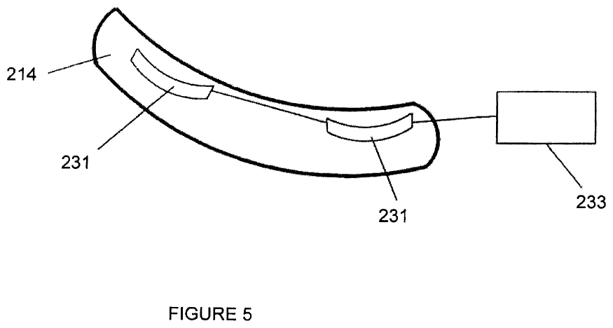

The deflector itself can have an additional and separate heating and cooling system incorporated therein to assist in thermal transfers within the system. Electrical heat can be provided to all or some areas of the deflector to further control thermal transfers. FIG. 5 shows deflector 214 having heaters 231 incorporated therein. The heaters are connected to a power source 233 which would be located external the granular bed. The heaters 231 could be heater tubes or plates or any other suitable means including but not limited to nano tubes or carbon fibers. Since these heaters are embedded within the deflector 214 they would be protected from any thermal fluids. Alternatively, the deflector could be manufactured to include a system of channels and conduits to receive its own thermal fluid.

The deflector and/or deflector inserts can be made of any suitable materials including but not limited to fabric, geotextiles, metals, polymers, elastomers, composites, shape memory material, nano materials, or any combination thereof.

Although aggregate of uniform size could be used to fill the entire granular bed support, it is preferred that the granular bed support includes a base layer 220 of a first variety of aggregate 210. This layer is located generally below the deflector 214 and has smaller aggregate particulates and smaller interstices than the top layer 222, located generally above the deflector 214. In this embodiment, the thermal fluid will flow primarily through the top layer 222 as the interstices in this layer are greater than those in the bottom layer. This helps to direct the thermal fluid along the top of the granular bed support. In another embodiment, the deflector can also divide, or partially divide the envelope into layers or regions. This would be beneficial if for example large granular units are required in a region close to the top surface 204 of the granular bed support 200 and smaller units are required for support in regions far from the top surface 204 of the granular bed support 200.

The size of the aggregate particulates 226 can vary depending on the size of the part being processes. In most applications, a diameter of ¼ inch to 1 inch is preferred. Particularly, a diameter of inch ½ is preferred for the top or thermal system layer 222 as it provides a suitable porosity that allows the thermal fluid to pass through without high pressures for typical molding applications. However, an aggregate diameter of up to 12 inches may be desirable, especially for large parts, such as wind turbine blades.

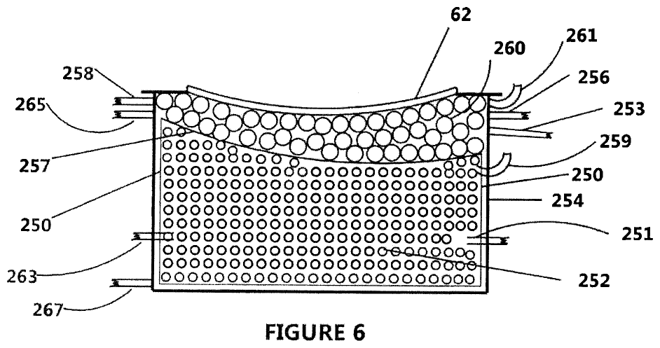

In an alternative embodiment, shown in FIG. 6, the deflector can be molded out of the aggregate. In this embodiment, a deflector volume adjustable retaining vessel 250 is filled with aggregate 252 and placed within a support volume adjustable retaining vessel 254. During set up, the aggregate 252 is partially jammed and then physically manipulated such that the top surface 257 is shaped to the desired deflector shape. Once the deflector shape is achieved, the aggregate 252 is fully jammed using a first vacuum port 251 coupled to the deflector volume adjustable returning vessel 250. Then the support volume adjustable retaining vessel 254 is filled with aggregate 260. The aggregate 260 is jammed via vacuum port 253 to support the mold, part, or mold skin. The support volume adjustable retaining vessel 254 includes a thermal system having at least one inlet 256 and at least one outlet 258 through which the thermal fluid is passed. The deflector volume adjustable retaining vessel 250 and the support volume adjustable retaining vessel 254 can optionally be coupled to prevent movement relative to each other. In this embodiment, there is no infiltration of the thermal fluid into the deflector volume adjustable retaining vessel 250. Each of the deflector volume adjustable retaining vessel 250 and the support adjustable returning vessel 254 include fill ports 259 and 261, respectively, and air inlet ports 263 and 265, respectively. The support adjustable volume returning vessel 254 also includes a drain 267.

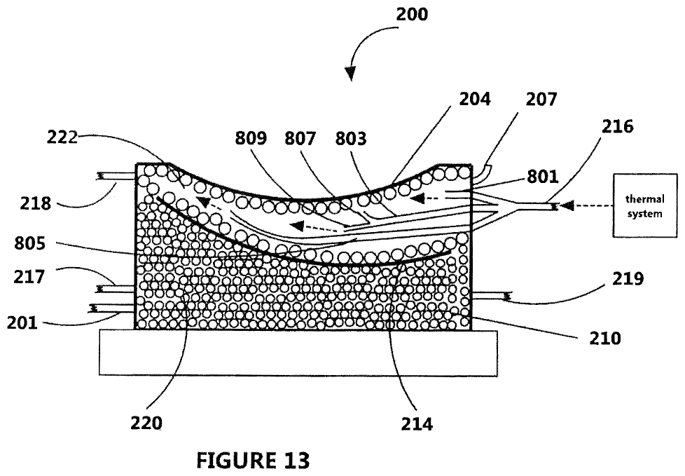

In an alternative embodiment of the thermal system, multiple inlets are provided at various points along the thermal fluid path. As shown in FIG. 13, the common thermal inlet 216 splits into several branched 801, 803 and 805. The aggregate particles in FIG. 13 have been omitted to clearly show the branches of the inlet 216 and the flow of the thermal fluid shown by the arrows with broken lines. Each branch could further divide, as shown with inlet 803 which further divides into branch 807 and 809. The branching of the inlet 216 allows for the introduction of thermal fluid at various points along the thermal fluid path, which reduces heat loss of the thermal fluid along the path from the inlet 216 to the outlet 218. This design is also used to provide increased heat to areas of the mold, part, liner or membrane subject to differential cooling. The branched inlets allow for hot thermal fluids to be sent to regions of the granular bed which are far from the thermal fluid inlet without having to pass through interstices between aggregate particles. This reduces heat loss to the aggregate particles.

The deflector can be used in combination with localized heat provided to specific areas of the mold as disclosed in U.S. Pat. No. 9,211,660.

The deflector in any embodiment can be shaped such that the thermal flow direction, velocity, and turbulence pattern can be somewhat controlled and the transfer of heat from the thermal fluid to the part is more efficient and uniform. Uniform temperatures of particular importance during part manufacture to provide more consistent mechanical properties throughout the manufactured part.

The deflector helps to provide more effective management of thermal transfer between the mold, part or mold skin and the granular bed and allows for the addition or reduction of thermal energy in preferred regions. This allows to more evenly, consistently and uniformly distribute energy to areas of the mold that have similar masses and where masses vary in areas of the mold, uneven transfers can be encouraged. This system allows transfer of energy to the mold or part and is advantageous in saving time and energy during production.

The thermal system can be utilized in several different parts of the molding process as well as in different types of molding applications. The system can be used during infusion molding, resin transfer molding with light molds, resin transfer molding and can be also used during the process curing portion of part production.

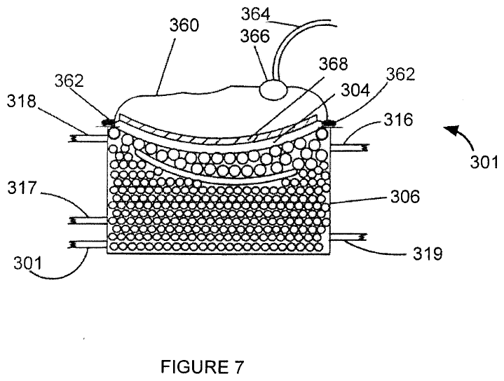

Use of the deflector in infusion molding is shown in FIG. 7. In this arrangement the volume adjustable retaining vessel 306 supports a mold 304 on the top surface thereof. The granular bed is fitted with a vacuum line 319 for jamming the aggregate and an air inlet 317 for releasing the aggregate. The granular support bed 300 contains a deflector 314, inlet 316 and an outlet 318 for the thermal fluid. A drain 301 is provided to drain the thermal fluid. A counter mold 316 is attached to the granular support bed 300 and seals 362 are used to provide a seal therebetween. A negative pressure vacuum is applied using the vacuum line 364 which attaches to the vacuum port 366 of the counter mold 360. This evacuates air from the cavity between the film counter mold 360 and the mold 304 which causes a positive atmosphere pressure to push the resin 368 and/or any other suitable molding materials known to a person skilled in the art, into the mold cavity. If any fibers reinforcement is used this process would push the resin into the fiberous enforcement. During this process the thermal system is used to control the temperature of the mold. In some embodiments it may be desirable to direct heat to certain parts of the mold that could be subject to differential cooling. Additionally, the thermal system can be used to remove heat from the mold 304 and part made from the resin 368. By controlling the thermal properties of the part during the molding and curing stage, the structural properties of the part can be improved.

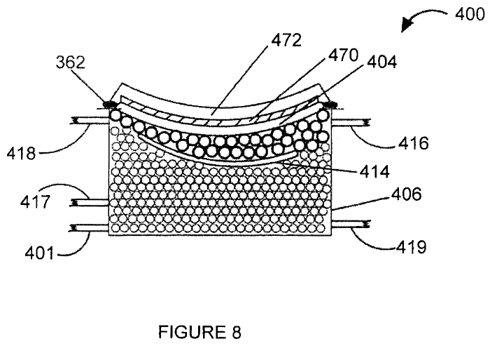

FIG. 8 shows use of the thermal system and resin transfer molding with light molds. The granular support bed 400 includes a vacuum port 419 for jamming aggregate and an air port 417 for releasing aggregate. In this molding process the granular support bed 400 incorporates a volume adjustable retaining vessel 406 which is coupled to a semi-flexible mold 404 which essentially makes up the top surface of the volume adjustable retaining vessel. Within the volume adjustable retaining vessel there is the deflector 414 to direct the thermal fluid. The thermal fluid enters the granular support bed through inlet 416 and exits through outlet 418. The system also uses a top semi-flexible mold 472 which provides a mold for the backside of the eventual part. Resin and fibrous material 470 is located between the top flexible mold 472 and the semi-flexible mold 404. As in the injection molding embodiment, the thermal system is used to control the thermal properties of the resin and fibrous material during the molding and curing process. When necessary the thermal fluid is drained through drain 401.

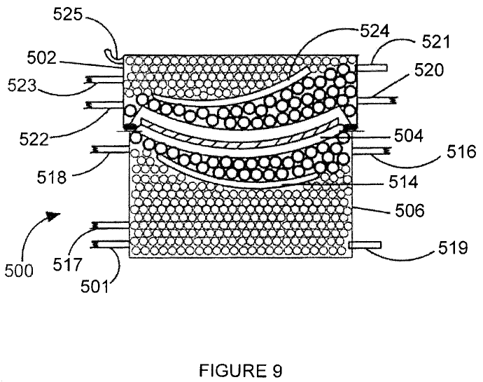

FIG. 9 depicts use of the thermal system in resin transfer molding. This method uses two granular support beds. A bottom granular support bed 500 and a top granular support bed 502 each having vacuum ports 519 and 521 respectively and air ports 517 and 523 respectively for jamming and releasing aggregate. FIG. 9 shows the thermal system integrated into the bottom support bed 500. The thermal system for the bottom granular bed has an inlet 516 and outlet 518 as well as a drain 501. The thermal system for the top granular bed has and inlet 521 and outlet 523 as well as drain 525. The bottom support bed 500 has a volume adjustable retaining vessel 506 with a mold 504 which makes the top surface of the volume adjustable retaining vessel 506. The thermal system further includes a first deflector 514 for helping to control the distribution of thermal energy to the mold 504. The top granular support bed 502 can optionally have its own thermal system. FIG. 9 shows the top granular support bed 502 incorporating the thermal system which includes inlet 520 and outlet 522 as well as the deflector 524.

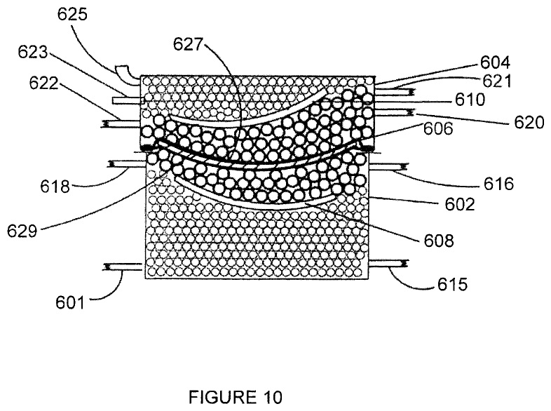

The thermal system also has uses in post process curing. After parts are about 80% cured and in stable configuration, the part is solidified however maximum cure has not been reached. For some applications, the part is removed from the mold and further heated to maximize curing. This additional heating can be done with or without pressure and by any means known to a person skilled in the art, but common known methods are by autoclave or oven. This process is slow and costly and often takes many hours to complete. The current thermal system can be utilized in the post curing process by using a granular support bed incorporating the deflector and thermal system to support the part. A bottom granular bed 602 is used to support the part and a second top granular bed is shaped to sit on top of the part such that the part is enclosed between the bottom bed 602 and top granular bed 604, as shown in FIG. 10. The bottom bed 602 has a thermal system including inlet 616, outlet 618, drain 601 and deflector 608. The top granular bed 604 has a thermal system including inlet 620, outlet 622, drain 625 and deflector 610. The part 606 is located between the bottom granular support bed 602 and the top support bed 604. Optionally, each of the granular beds 602 and 604 can be fitted with membranes (627 on top and 629 on the bottom bed) located between the granular beds and the parts. During the post cure process heat can be added via the top and bottom thermal system. This method eliminates the need for costly autoclave or ovens. The heating via these thermal systems is more efficient than previous known methods and thus the cost of achieving a high cure can be reduced. As with other embodiments, each granular bed has a vacuum port (617 on the bottom and 621 on the top bed) and airport (619 on the bottom bed and 623 on the top bed) for jamming or releasing the aggregate respectively.

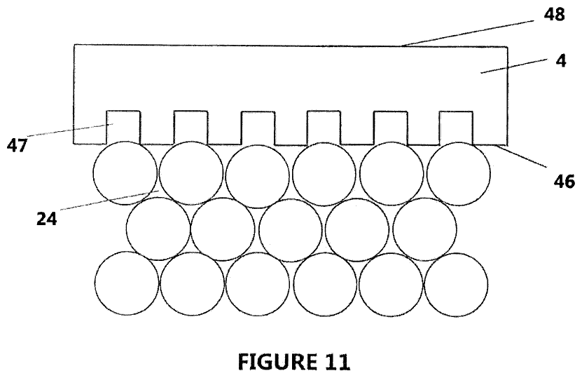

In any embodiment containing at least one mold, the molds can includes a series of channels on the bottom surface thereof. This is shown in FIG. 11 where the mold 4 contains channels 47 which are adjacent the aggregate particulates 26. These channels 47 allow the thermal fluid to be in closer proximity to the top surface 48 of the mold 4. This increases the thermal transfer between the thermal fluid and the eventual part.

Although various preferred embodiments of the present invention have been described herein in detail, it will be appreciated by those skilled in the art that variations may be made thereto without departing from the appended claims.

1. A support bed for use in molding comprising
an adjustable granular bed comprising aggregate material retained in a retaining vessel, at least a portion of said retaining vessel being of a flexible sheet material, an arrangement for fluidizing said aggregate material and at least one arrangement for stressing said aggregate material;
said adjustable granular bed, in a stressed state of said aggregate material, having said flexible sheet material and stressed aggregate material shaped to generally uniformly support said rear support face of a molding component;
said adjustable granular bed, when said arrangement for fluidizing said aggregate material is activated, being reconfigurable as the aggregate material is displaceable such that the shape of the adjustable support can be altered to follow the shape of the molding component;
said arrangement for stressing said aggregate material causes jamming of said aggregate material and support of said molding component and said arrangement for fluidizing said aggregate material allows for reconfiguration of said aggregate material; said support bed further including at least one thermal system to facilitate the circulation of a thermal fluid through the granular bed; and wherein
a deflector for directing the thermal flow contained within said granular bed.

2. A support bed according to claim 1 wherein said at least one thermal system having at least one inlet for introducing a thermal fluid into the support bed and at least one outlet through which the thermal fluid exits the support bed.

3. A support bed according to claim 2 further comprising at least one volume adjustment device for adjusting the internal volume of the support bed.

4. A support bed as claimed in claim 3 wherein the volume adjustment device is attached to a wall of the retaining vessel.

5. A support bed according to claim 4 wherein the volume adjustment device is coupled to the deflector.

6. A support bed according to claim 2 5 wherein said at least one thermal system further including a control system having a control apparatus for dynamically adjusting the temperature of the thermal fluid.

7. A support bed according to claim 6 wherein said control system having a control apparatus dynamically adjusts at least one further property of the thermal fluid including pressure and flow velocity.

8. A support bed according to claim 7 wherein the at least one thermal system has multiple inlets.

9. A support bed according to claim 7 wherein the at least one thermal system has multiple outlets.

10. A support bed according to claim 1 wherein said deflector is embedded within the aggregate material.

11. A support bed according to claim 1 wherein the deflector is coupled to at least one part of said granular bed.

12. A support bed according to claim 1 wherein said granular bed contains at least 2 regions, each region containing an aggregate having a different property from another region.

13. A support bed according to claim 12 wherein the differing property is at least one of the following; size, shape, density, material, hardness and conductance.

14. A support bed according to claim 1 wherein said deflector includes at least one insert coupled thereto to direct the flow of the thermal fluid.

15. A support bed according to claim 1 wherein the temperature of said deflector is controlled by a deflector thermal system.

16. A support bed according to claim 1 wherein said deflector includes sensors to communicate the temperature at a predefined point along the deflector to a control panel.

17. A support bed according to claim 1 wherein said deflector is of similar shape to the molding component supported on top of the support bed.

18. A support bed according to claim 1 wherein the deflector is comprised of multiple sections independent from one another.

19. A support bed according to claim 10 wherein the granular bed contains at least 2 regions, including at least an upper region and an adjacent region positioned below the upper region, and the top surface of the adjacent region is formed to the desired deflector shape and forms the thermal deflector.

20. A support bed according to claim 1 wherein said thermal system includes a network of conduits to distribute the thermal fluids to predetermined areas of the granular bed which require variation in temperature.
